(19) United States
(12) Patent Application Publication
(10) Pub. No.: US 2001/0019368 A1
(43) Pub. Date: Sep. 6, 2001

(54) Broadcast data receiving

(75) Inventors: Richard Holme, Leeds (GB); Jon Frost, Bradford (GB)

Correspondence Address: HEAD JOHNSON & KACHIGIAN, 228 W 17TH PLACE, TULSA, OK, 74119, US

(73) Assignee: Pace Micro Technology

(21) Appl. No.: 09/797,351

(22) Filed: Mar. 1, 2001

(30) Foreign Application Priority Data
Mar. 1, 2000 (GB) 0004811.6

(51) Int. Cl. H04N 5/50; H04N 5/44

(52) U.S. Cl. 348/734; 348/569

(57) ABSTRACT

The invention relates to a television system which includes a broadcast data receiver for processing received data and generating television programs via a display screen and capable of generating on the screen a range of user selectable options relating to functions or modes of operation of the system. The user makes the selection of an option by using a remote control device which includes a light detection device and which can be pointed at the screen at a particular position to define a particular option to be selected. When the electron or CRT beam of the screen passes the field of vision of the light detecting device, a signal is transmitted to the broadcast data receiver and the position on the screen is determined and, with comparison to the known locations of the selectable options on the screen, the appropriate option is selected and performed.

Broadcast data receiving apparatus is typically provided to allow the reception of transmitted data which, when processed, allows for the generation of television programmes on a television set and which programmes typically comprise a combination of video, audio and/or text data. The television set can include as an integral part thereof the broadcast data receiving apparatus or alternatively, may be connected to a self contained broadcast data receiving apparatus.

With the advent of digital data broadcast systems, the range of services and functions which can be provided to the user via the broadcast data receiver has increased dramatically.

Said receiver apparatus typically includes a means to allow user selections to be made to select particular functions or modes of operation of the apparatus and, while originally, this was performed by the selection of buttons mounted on the television set apparatus itself, the most normal and conventional form now used is to use a remote control device. The remote control device allows for the generation of an infrared signal which is representative of a particular control signal generated by the remote control device in response to a user selection of a particular button or buttons on the remote control device. The infrared signal is transmitted to and received by the digital data receiver as long as the remote control device generates a signal in the general direction of the receiver so as to be picked up by the same. When the infrared signal is received, the broadcast data receiver processes the same and the appropriate function or mode change is undertaken. However, as the range of selectable functions and modes increases, so there is perceived to be a need for users to be able to more efficiently, accurately and quickly make function selections in conjunction with the apparatus. One known proposed solution is to provide a “mouse” control on the remote control device in a similar fashion to the mouse which is typically provided for personal computers. However, the incorporation of a mouse device into a remote control is a relatively complex matter and the complexity of data which is required to be transmitted from the remote control device incorporating the mouse is regarded as being a significant disadvantage.

It is known to utilise light pens for limited purposes and, for example, in U.S. Pat. No. 4,847,696 to utilise a light pen to activate a programme recording device but this is used as a single option selector and is not able to select one of a range of options. U.S. Pat. No. 5,119,075 utilises the use of two probes in contact with a display screen at different locations on the screen, but this requires the user to be in a position in which they can contact the screen with the probes and is therefore uncomfortable for the user.

The aim of the present invention is to provide a remote control device which incorporates a means of allowing user selection of functions or modes of operation of a broadcast data receiver and/or television set and to allow interaction between the remote control device and an on-screen display which displays the selection options available.

In a first aspect of the invention there is provided broadcast data receiving apparatus, said apparatus being provided to receive and process data to generate television programmes and said apparatus including a broadcast data receiver (BDR) operable by a remote control device which allows for the user selection of options relating to functions or modes of operation of said apparatus, said apparatus further including a display screen connected to the broadcast data receiver and which is operated with a Cathode Ray tube electron beam and on which a range of user selectable options can be displayed when in an appropriate mode and characterised in that said remote control device includes a light sensitive detecting device which can be selectively directed by the user at a position on the screen to select one or a number of said options, said light sensitive detecting device activated when the Cathode Ray Tube (CRT) or electron beam of the display screen passes the position on the screen at which the light sensitive detecting device is pointed by the user and, upon activation, a signal is transmitted from the remote control device to the broadcast data receiver to allow the position on the screen at which the remote control device was directed to be identified.

Typically the position on the screen at which the detecting device is pointed by the user is determined with respect to the display screen and the position is then compared with the respective locations of the selectable options displayed on screen and the apparatus performs the option whose location matches the determined position of the light sensitive detection device on the screen.

The remote control device will transmit a signal to the broadcast data receiver upon activation of the light sensitive device by the electron or CRT beam. The signal is typically transmitted by an infrared signal or other wireless data transmission from the remote control device to the broadcast data receiver.

In one embodiment the remote control device further includes a light emitting means which, when the light detecting device is pointed at the screen, causes the position on the screen which matches that to which the light detecting device is directed to be indicated to the user. Typically the light emitted is sufficiently strong to allow the light to be viewed on the screen by the user, even when the user is sitting a removed distance from the screen such as for example 3-4 meters from the screen. By providing this, so the user can be certain that the device is being pointed at the required position on the screen.

With the activation of the device and the location of the field of vision detected with respect to the display screen, so the position can be compared with the location of the selectable options displayed on the screen and the apparatus performs the user option which location on the screen matches the determined position at which the light sensitive detection device was activated. This allows the user selected option to be identified and undertaken by the broadcast data receiver.

In order to process the information and detect the position at which the light detection device is directed on the display screen and hence make the appropriate user selection, the data is processed as follows in accordance with one embodiment:

The light detection device is provided to detect the time at which the electron or CRT beam on the display screen passes through the position on the screen of the field of vision of the light sensitive detection device.

When the electrode beam passes the position the same is detected by the device and a signal is generated by the remote control device and transmitted to the broadcast data receiver. The broadcast data receiver can identify from the display screen to which the same is connected, the time at which the CRT beam started on the screen, typically from the information in the form of the vertical synchronisation signal (VSync) at the start of a video frame, and, by calculating the time elapsed between the start point and the point of detection, in conjunction with being aware of the path of the CRT beam across the screen, so the XY co-ordinates of the position at which activation of the light sensitive device occurred is identified.

Upon detecting the XY co-ordinates, the data processing means determines the user selectable options displayed on the display screen at that time and position and makes the required user selection.

In accordance with a further aspect of the invention there is provided a method of selecting an option from a range of selectable options displayed on a screen utilising an electron or CRT beam, said method utilising a broadcast data receiver to generate the display on the screen and said broadcast data receiver controllable by a remote control device to allow the selection of one or a number of options from a range of options displayed on the screen characterised in that said remote control device includes a light detection device and the method includes the steps of the user moving the device to point to a selected position on the screen to lie on the option which the user desires to select, said light detection device detecting and activated by the electron or CRT beam of the display screen passing the position on the screen at which the light detection device is pointed and, upon activation, a signal is generated by the remote control device and transmitted to the broadcast data receiver whereupon the broadcast data receiver obtains data relating to the time at which the CRT beam started on the screen and calculates the time elapsed between the start point and the point of activation of the light detection device and, being aware of the path of the CRT beam, calculates the XY co-ordinates of the selected position on the display screen and with reference to the known positions of the respective user selectable options on screen at that time, identifies the option displayed at the XY co-ordinates and then performs the identified option.

In one embodiment the signal transmitted from the remote control device is via wireless data communication means.

In one embodiment in the calculation of the position on the screen, account is made of the time which elapses between the light detection device being activated and the signal being transmitted to and received by the broadcast data receiver. In an alternative embodiment the data transmitted to the broadcast data receiver includes a time of activation such that any delay in the receipt of the signal from the remote control device does not affect the calculation of the position which is based on the time data received.

In order to preserve battery power for the light detection device as herein described, it is envisaged that the device includes a means whereby the light detection device can be switched on or off by the user and, if the light detection device is detected to be inactive over a preset period of time in that it has not been pointed to the screen or been activated by the CRT beam, then the same will be automatically switched off so as to preserve consumption.

Although the invention is described in conjunction with broadcast data receiving apparatus it should be appreciated that the invention of the light detection device can be used with any form of apparatus which includes a display screen and in which a periodic change in condition can be detected by a light detecting device and the position of the detection area of the same on the display screen can be determined.

Thus, in accordance with the invention there is provided a means whereby a remote control device can be used to move a pointer or select an option displayed on the screen of a CRT television screen. The position of the pointer or option selected is achieved by the sending of a response to the Broadcast Data Receiver when the CRT beam of the television screen is detected by a light sensitive device in the remote control. The response to the Broadcast Data Receiver by either electrical or infra red means. The Broadcast data receiver then uses the timing of reception of the response in conjunction with the known passage of the CRT beam across the display screen to then ascertain where the CRT beam was on the screen in terms of the XY co-ordinates of the same on the screen at the instant of the response being generated. By this, if a range of options are being displayed, the Broadcast data receiver identifies the XY location with the particular option at that location on the screen and thereby activates the option.

Specific embodiments of the invention will now be described with reference to the accompanying drawing, wherein:

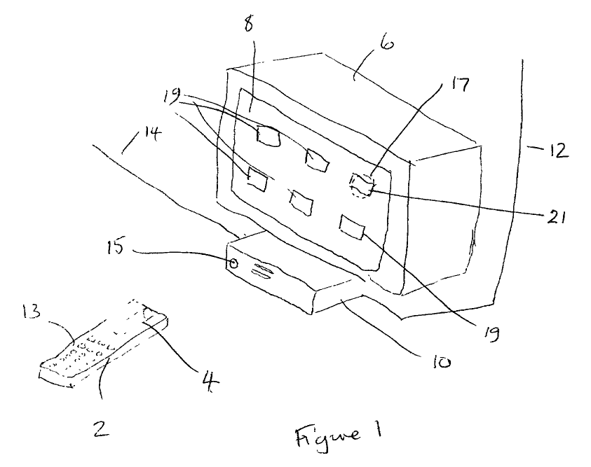

FIG. 1 illustrates an embodiment of the invention.

Referring to FIG. 1, there is illustrated one embodiment of the apparatus which can be used to perform the invention, said apparatus comprising a remote control device 2 which includes a light detection device 4. A display apparatus in the form of a television set 6 with a display screen 8 is provided and, in this embodiment, a separate broadcast data receiving apparatus 10 is provided in connection with the television set and also in connection with a means for receiving data 12 and a further means for transmitting and/or receiving data 14. The broadcast receiving apparatus is provided to process received data such as that received via satellite, cable or terrestrial systems and, from the same, generate television programmes for display on the television set screen incorporating video, audio and/or text. Further services can be provided so that the apparatus can be used to generate further services such as e-mail, menu's of user selectable options, games, shopping and so on, all for display on the screen.

As the range of user selectable functions of the apparatus increases, so there is a need for interactive user selection apparatus which allows the user to make selections in conjunction with viewing of the display screen. In one embodiment, the user may select to continue to use the conventional remote control device to make selections of options via buttons 13 and the generation of infra red signals to be received by the receiver 15 in the data receiver 10 in the normal manner but this requires the user to view the options on screen, for the options to each be allocated a number or symbol which is displayed on screen and for the user to then depress the appropriate number or symbol on the remote control.

In accordance with the present invention, for all or certain function and option selections they can change the operating condition of the remote control device 2, or use an alternative device, by utilising the light detection device 4.

The light detection device can be provided in one of two formats. In the first format (not shown), the device is placed onto the display screen by the user and in this form, there is provided a photo-detector which detects the CRT electron beam as it scans along the display screen. As the detector device is placed on the screen, it will only detect the electron beam as it passes the point of contact between the detection device and the screen and, at that instant, the detector is activated and transmits a signal to the remote control device.

In an alternative, preferred option, the remote control device as shown in FIG. 1 is used and, as normal, the device can be operated without physical connection with the television apparatus. The device can be positioned a distance away from the screen as shown and can include a light detection device such as a photo-detector. The remote control device and photo-detector can be pointed by the user towards a specific position on the display screen, in this case as indicated by broken lines 17, typically to select option 21 of a range of options 19 displayed on the display screen. Preferably, the field of vision of the device is relatively narrow so that, for example, the detector is sensitive to light in only a certain direction. This can be achieved by optical design such as by using a narrow angle lens in a darkened tube in the light detecting device. In this embodiment the detector detects when the light of the CRT beam of the television is within the narrow field of vision 17 on the display screen. When the device is activated and detects the CRT or electron beam a signal is generated by the remote control device.

In the embodiment shown, regardless of which of the light detection devices is used, the signal is transmitted from the remote control device by infrared to the broadcast data receiver.

The signal generated from the light detector device is generated at the time when the electron beam is detected, or alternatively a known time thereafter. When received at the broadcast receiving apparatus, the time of reception is logged and by measuring this time relative to a reference time, typically the vertical synchronisation signal (VSync) at the start of a video frame, and the known path of the electron beam over the display screen, it is possible to obtain a time measurement from which an accurate position of the field of vision and hence position of activation of the light sensitive detecting device with respect to the display screen can be derived. The accurate position can be derived in terms of XY co-ordinates on the screen and these co-ordinates can be compared with the location of the user selectable options 19 displayed on the screen so as to identify the option which has been selected by the user. The selected option can then be performed by the processing means of the broadcast data receiver.

It can be necessary in some instances to calibrate this measurement for each display screen that the device is to be used with. By using this means of processing, the only information that needs to be transmitted from the light detection device to the broadcast data receiver is a signal to indicate the time of the occurrence of detection of the electron or CRT beam. Thus, the signal which is sent serves to identify the information signal as being that of the light detection device and hence is a relatively short signal. It is also preferred that the data does not interact with other equipment with infrared reception means.

Thus, the invention implements a light detection device to act as a means for control which allows the user the freedom to select any position on a display screen so as to select user selectable options or other features and, to do so and move the control means around the screen in any required configuration and direction and this represents a significant advantage over the remote control device where only scrolling in one or two directions was previously possible. The options which can be chosen can be from a range of options such as choosing a particular channel from a number of channels, requesting the operation of the broadcast data receiver to provide a particular service, the operation of the receiver to provide further information, display screen formats and so on

1. Broadcast data receiving apparatus, said apparatus being provided to receive and process data to generate television programmes and said apparatus including a broadcast data receiver (BDR) operable by a remote control device which allows for the user selection of options relating to functions or modes of operation of said apparatus, said apparatus further including a display screen connected to the broadcast data receiver and which is operated with a Cathode Ray tube beam and on which a range of user selectable options can be displayed when in an appropriate mode and characterised in that said remote control device includes a light sensitive detecting device which can be selectively directed by the user at a position on the screen to select one or a number of said options, said light sensitive detecting device activated when the Cathode Ray Tube (CRT) beam of the display screen passes the position on the screen at which the light sensitive detecting device is pointed by the user and, upon activation, a signal is transmitted from the remote control device to the broadcast data receiver to allow the position on the screen at which the remote control device was directed to be identified

2. Broadcast data receiving apparatus according to claim 1 characterised in that the position on the screen at which the detecting device is pointed by the user is determined with respect to the display screen and the position is then compared with the respective locations of the selectable options displayed on screen and the apparatus performs the option whose location matches the determined position of the light sensitive detection device on the screen.

3. Broadcast data receiving apparatus according to claim 1 characterised in that the remote control device transmits a signal to the data broadcast receiver upon activation of the light sensitive device by the CRT beam.

4. Broadcast data receiving apparatus according to claim 3 characterised in that said signal is transmitted by an infrared signal or other wireless data transmission from the remote control device to the broadcast data receiver.

5. Broadcast data receiving apparatus according to claim 1 characterised in that the remote control device includes a light emitting means which when the light detecting device is pointed at the screen causes a position on the screen which matches that to which the light detecting device is directed to be indicated to the user.

6. A method of selecting an option from a range of selectable options displayed on a screen utilising an electron or CRT beam, said method utilising a broadcast data receiver to generate the display on the screen and said broadcast data receiver controllable by a remote control device to allow the selection of one or a number of options from a range of options displayed on the screen characterised in that said remote control device includes a light detection device and the method includes the steps of the user moving the device to point to a selected position on the screen to lie on the option which the user desires to select, said light detection device detecting and activated by the electron or CRT beam of the display screen passing the position on the screen at which the light detection device is pointed and, upon activation, a signal is generated by the remote control device and transmitted to the broadcast data receiver whereupon the broadcast data receiver obtains data relating to the time at which the CRT beam started on the screen and calculates the time elapsed between the start point and the point of activation of the light detection device and, being aware of the path of the CRT beam, calculates the XY co-ordinates of the selected position on the display screen and with reference to the known positions of the respective user selectable options on screen at that time, identifies the option displayed at the XY co-ordinates and then performs the identified option.

7. A method according to claim 6 characterised in that the signal transmitted from the remote control device is via wireless data communication means.

8. A method according to claim 6 characterised in that in the calculation of the position on the screen, account is made of the time which elapses between the light detection device being activated and the signal being transmitted to and received by the broadcast data receiver.

9. A method according to claim 6 characterised in that the data transmitted to the broadcast data receiver includes a time of activation such that any delay in the receipt of the signal from the remote control device does not affect the calculation of the position which is based on the time data received.
